(19) United States
(12) Patent Application Publication
(10) Pub. No.: US 2026/0210783 A1
(43) Pub. Date: Jul. 23, 2026

(54) TORQUE SENSOR

(71) Applicant: Gates Corporation, Denver, CO (US)

(72) Inventors: Brian Graichen, Leonard, MI (US); David Crowther, Bloomfield Hills, MI (US); Nithin Reddy Karna, Walled Lake, MI (US)

(73) Assignee: Gates Corporation, Denver, CO (US)

(21) Appl. No.: 19/141,253

(22) PCT Filed: Dec. 19, 2023
(86) PCT No.: PCT/US2023/084941

§ 371 Date: Jun. 19, 2025

Related U.S. Application Data
(60) Provisional application No. 63/433,583, filed on Dec. 19, 2022.

(51) Int. Cl. G01L 3/10

(52) U.S. Cl. CPC G01L 3/104

(57) ABSTRACT

A torque sensor is provided for detecting a torque applied to a rotating component. The torque sensor has a torsion disc that can have a radial dimension that is greater than an axial dimension to provide space for other components positioned around the rotating component. In some embodiments, the torsion disc has an inner portion engaged with a crankshaft of a bicycle and has an outer portion engaged with a drive wheel or another component engaged with the drive wheel. When a torque is applied to the crankshaft, the torsion disc deforms and the inner portion rotates relative to the outer portion. A combination of magnets and sensors detects this relative movement which is proportional to the torque applied to the crankshaft.

### CROSS-REFERENCE TO RELATED APPLICATIONS

This application claims priority to U.S. Provisional Patent Application Ser. No. 63/433,583 filed Dec. 19, 2022, which is incorporated herein in its entirety by reference.

### FIELD OF THE INVENTION

The disclosure relates to a torque sensor, in particular for an electric bicycle or “e-bike,” that detects a torque applied to a component such as a crankshaft.

### BACKGROUND OF THE INVENTION

Torque sensors are incorporated in a variety of devices, including some e-bikes. E-bikes have an electric motor that selectively assists a user by supplying additional power to the e-bike under certain conditions like ascending a hill. Some e-bikes have a controller that determines when and how a battery supplies electric power to the electric motor to assist a user. One or more sensors can transmit information to the controller to aid in this determination.

One sensor used in some e-bikes is a cadence sensor that detects the rate at which a component rotates. For example, a cadence sensor can be positioned to detect the rotation rate of a crankshaft of an e-bike. The cadence sensor transmits information to the controller, and once the crankshaft rotates above a predetermined rate the controller supplies electric power to the electric motor to assist the user by reducing the input energy required from the user to power the bicycle.

Another sensor is a torque sensor that detects a torque applied to a component. Measurements from a torque sensor are useful inputs for a controller since a torque applied by a user to a crankshaft is directly related to an effort applied by the user, regardless of whether the bicycle is traveling fast or slow. Some prior art torque sensors have a secondary shaft concentrically disposed around a primary shaft where one end of the secondary shaft is connected to the primary shaft, and the other end of the secondary shaft is connected to an output. When a torque is applied to the primary shaft, a torsion angle of the secondary shaft relative to the primary shaft is measured. Alternatively or additionally, a stress on the secondary shaft is measured, and these measurements are associated with a torque that the controller can utilize to determine when and how to supply electric power to the electric motor. For instance, the torque sensor transmits information to the controller, and once the measured torque rises above a predetermined threshold, the controller supplies electric power to the electric motor to assist the user.

The concentric secondary shaft extends along a substantial portion of the crankshaft in an axial direction. The dimension of the crankshaft in the axial direction is limited by crank arms that connect pedals to the crankshaft. In some devices, like a transmission of a bicycle, other components must be positioned around the crankshaft, and a concentric secondary shaft is unworkable. Embodiments of the present disclosure provide a torque sensor with a torsion disc that occupies considerably less space in the axial direction, among other benefits described herein.

### SUMMARY OF THE INVENTION

Embodiments of the present disclosure specifically relate to a novel torque sensor that detects a torque applied to a component while occupying less space, particularly in an axial direction. A combination of magnets and sensors provides accurate positional readings of a torsion disc that deforms in the presence of a torque and that extends farther in a radial direction than the axial direction.

It is one aspect of various embodiments of the present disclosure to provide a torque sensor with a torsion disc that deforms in response to a torque applied to a component such as a crankshaft. In some embodiments, the torsion disc has an inner portion engaged with the crankshaft and an outer portion engaged with another component. When torque is applied to the crankshaft, the torsion disc deforms such that the rotational position of the inner portion is displaced from the rotational position of the outer portion. The difference in rotational positions of the inner and outer portions corresponds to the torque. A controller receives information from the sensor(s), including a torque, and can optionally supply electric power to an electric motor.

It is another aspect of various embodiments of the present disclosure to provide a torque sensor with a torsion disc that extends farther in a radial direction than an axial direction. In some devices, it is advantageous to position various components around the rotating component, which leaves only a limited amount of space in the axial direction to place a torque sensor. The torsion disc has an inner portion positioned within an outer portion in the radial direction as well as other structural arrangements to reduce the size of the torsion disc and the overall torque sensor in the axial direction. In some embodiments, the width of the torsion disc in the axial direction is between approximately 5 mm and 14 mm. In various embodiments, the width of the torsion disc in the axial direction is approximately 9 mm.

In some embodiments, two arms serve as the outer portion of the torsion disc of the torque sensor. The inner portion can have an annular shape positioned around the component such as a crankshaft, and two central portions extends outward from the inner portion in the radial direction. A first arm extends from a first central portion, and the first arm extends in an arc about the inner portion. A distal end of the first arm is offset from a second central portion by a gap. When a torque is applied to a component engaged with the inner portion, such as a crankshaft, the torsion disc deforms and the inner portion rotates relative to the outer portion. As a result, the gap shrinks in size as the torsion disc deforms. When subjected to a large torque, the gap can close such that the distal end of the first arm contacts the second central portion, and this effectively establishes a maximum detectable torque. A second arm extends from the second central portion and is similarly arranged as the first arm.

In some embodiments, the first arm and the second arm are each engaged with an output or another component. In the context of an e-bike, this component can be a drive wheel or another component engaged with the drive wheel, and the torque sensor detects an effort of the user applied to a crankshaft relative to the drive wheel. The configuration of the torsion disc, in particular the arrangement of the inner portion within the outer portion, allows the torsion disc and the torque sensor to integrate with other components of the e-bike. Specifically, the configuration of the torsion disc bridges the space between a crankshaft and a drive wheel or another component engaged with the drive wheel and minimizes the space occupied by the torque sensor in an axial direction.

Moreover, due to the arrangement of the arms of the torsion disc, each arm is engaged with the second component at two points to ensure that deformation occurs through each arm in response to a torque. Pins extending through two apertures in each arm and into the second component can serve as the two points of connection. Moreover, in some embodiments, the two points lay on an arcuate line or a portion of a circular line that is centered on the rotational axis of the crankshaft and/or torsion disc to ensure the movement and deformation of the torsion disc are limited to the circular direction about the rotational axis.

It is an aspect of embodiments of the present disclosure to provide a torque sensor with magnets and sensors to generate torque readings with improved accuracy. As noted herein, when subjected to a torque, the inner portion of the torsion disc rotates relative to the outer portion. Magnets and sensors determine the rotational positions of the inner and outer portions of the torsion disc and, thus, a relative movement of the inner and outer portions in the presence of a torque. In some embodiments, these positional readings are the information transmitted to a controller. In other embodiments, the torque sensor determines the torque or other readings from these positional readings, and the torque or other readings are the information transmitted to a controller.

In one embodiment, a set of inner magnets is engaged with the inner portion of the torsion disc, and the inner magnets have alternating polarities. Similarly, a set of outer magnets is engaged with the outer portion of the torsion disc, and the outer magnets have alternating polarities. An inner sensor such as a Hall sensor is positioned to detect the polarities of the set of inner magnets as one magnetic encoder, and an outer sensor such as a Hall sensor is positioned to detect the polarities of the set of outer magnets as another magnetic encoder. The time at which the inner sensor detects a transition of polarities of inner magnets is compared to the time at which the outer sensor detects a transition of polarities of corresponding outer magnets to determine a time offset. This time offset is used to determine a rotational offset between sets of magnets, deformation of the torsion disc, and a torque. As more torque is applied to the crankshaft, the time offset between corresponding polarity transitions of inner and outer magnets increases.

A further consideration is the rate at which components like the torsion disc rotate. For a given torque, a faster rotating torsion disc will result in a smaller time offset than a slower rotating torsion disc. Thus, the time offset is a function of both rotation speed and rotational offset between sets of magnets (i.e., deformation of the torsion disc and torque). The rotation speed can be determined in a number of ways such as by a separate cadence sensor, by the torque sensor itself, etc. Once the rotation speed is known, its effect on the time offset can be accounted for and eliminated to produce a time offset that relates directly to the deformation of the torsion disc and the torque.

In another embodiment, an inner tone ring with alternating teeth and notches is engaged with the inner portion of the torsion disc, and an outer tone ring with alternating teeth and notches is engaged with the outer portion of the torsion disc. The tone rings are made from a ferrous material. Therefore, a magnet-backed inner sensor and a magnet-backed outer sensor detect changes in the magnetic fields caused by the tone rings rotating by the sensors. Like other embodiments, when a torque is applied, a time offset between corresponding polarity transitions detected by the inner and outer sensors is used to determine the torque.

In yet a further embodiment, one or more strain gauges are used to determine the degree to which the torsion disc deforms in the presence of a torque. In one embodiment, a strain gauge is located between the inner and outer portions of the torsion disc, and the strain gauge generates a signal based on the amount of strain the torsion disc undergoes as the torsion disc deforms when a torque is applied to a crankshaft and the inner portion of the torsion disc. It will be appreciated that the torsion disc can have strain gauges in any location. The signals from the strain gauges are correlated to a torque. Thus, when a particular strain is detected, a controller can then determine the torque applied to the crankshaft.

It is an aspect of various embodiments of the present disclosure to provide a torque sensor with sets of magnets offset in the axial direction of a crankshaft rather than the radial direction. With a radial offset between sets of magnets, the sensors are thusly offset from the sets of magnets along the axis of the crankshaft. This arrangement can be sensitive to variations in distance between the sensors and the sets of magnets. This sensitivity is called runout and creates an error in the readings from the sensors. Some post-processing can reduce the effects of runout, but this then creates a time lag in the output of the sensor, which can inhibit the use of a torque sensor in various applications. Thus, in some embodiments, the sets of magnets are offset in an axial direction, and the sensors are offset in a radial direction, either inwardly or outwardly from the sets of magnets. With this arrangement, spatial variations between the magnets and sensors are reduced. Accordingly, the likelihood of runout and any attendant post-processing is reduced or eliminated.

A first aspect of the present disclosure is to provide a torque sensor for detecting a torque between a first component and a second component, comprising a torsion disc having an inner portion configured to be engaged with the first component; an outer portion configured to be engaged with the second component; and at least one central portion joining the inner and outer portions; an inner magnet associated with the inner portion of the torsion disc; an outer magnet associated with the outer portion of the torsion disc; and at least one sensor configured to detect a relative movement between the inner and outer magnets, which is proportional to the torque between the first component and the second component.

The torque sensor of the first aspect may include, optionally, that the inner portion has an annular shape configured to completely circumscribe the first component.

The torque sensor of the first aspect may include one or more of the previous embodiments and, optionally, that the at least one central portion of the torsion disc is a first central portion and a second central portion, and the outer portion of the torsion disc comprises a first arm extending from the first central portion and partially extending about the inner portion; and a second arm extending from the second central portion and partially extending about the inner portion.

The torque sensor of the first aspect may include one or more of the previous embodiments and, optionally, that the first arm comprises two apertures proximate to a distal end of the first arm, and wherein two apertures are configured to receive two fasteners to engage the first arm with the second component.

The torque sensor of the first aspect may include one or more of the previous embodiments and, optionally, that the two apertures are positioned on a circular line centered on a rotational axis of the torsion disc.

The torque sensor of the first aspect may include one or more of the previous embodiments and, optionally, that the first and second arms are symmetric about a rotational axis of the torsion disc.

The torque sensor of the first aspect may include one or more of the previous embodiments and, optionally, that a distal end of the first arm of the torsion disc is offset from the second central portion of the torsion disc by a gap distance, and a distal end of the second arm of the torsion disc is offset from the first central portion of the torsion disc by the gap distance to establish a maximum twist angle between the inner and outer portions and to establish a maximum detectable torque.

The torque sensor of the first aspect may include one or more of the previous embodiments and, optionally, that the torsion disc is made from a material having a maximum yield strength of at least 1200 MPa.

A second aspect of the present disclosure is to provide a torque sensor for detecting a torque between a first component and a second component, comprising an inner portion configured to be engaged with the first component; an inner magnet associated with the inner portion; a first central portion extending from the inner portion, and a second central portion extending from the inner portion; an outer portion configured to be engaged with the second component, wherein the outer portion comprises a first arm extending from the first central portion, wherein the first arm partially extends about the inner portion of the torque sensor; and a second arm extending from the second central portion, wherein the second arm partially extends about the inner portion of the torque sensor; an outer magnet associated with the outer portion; and at least one sensor configured to detect a relative movement between the inner and outer magnets, which is proportional to the torque between the first and second components.

The torque sensor of the second aspect may include, optionally, that the inner magnet is one of a set of inner magnets having alternating polarities and connected to the inner portion of the torque sensor, wherein the outer magnet is one of a set of outer magnets having alternating polarities and connected to the outer portion of the torque sensor, and wherein the at least one sensor comprises an inner Hall sensor configured to detect the set of inner magnets and a rotational position of the inner portion of the torque sensor; and an outer Hall sensor configured to detect the set of outer magnets and a rotational position of the outer portion of the torque sensor, wherein a difference in rotational positions between the inner and outer portions is a twist angle that is proportional to the torque between the first and second components.

The torque sensor of the second aspect may include one or more of the previous embodiments and, optionally, that a first portion of the set of outer magnets is connected to the first arm proximate to a distal end of the first arm, and a second portion of the set of outer magnets is connected to the second arm proximate to a distal end of the second arm.

The torque sensor of the second aspect may include one or more of the previous embodiments and, optionally, that the inner portion of the torque sensor comprises an inner tone ring with alternating teeth and notches, and the outer portion of the torque sensor comprises an outer tone ring with alternating teeth and notches, and wherein the at least one sensor comprises an inner Hall sensor backed by the inner magnet, wherein the inner Hall sensor is configured to detect changes in a magnetic field of the inner magnet caused by rotation of the inner tone ring and configured to detect a rotational position of the inner portion; and an outer Hall sensor backed by the outer magnet, wherein the outer Hall sensor is configured to detect changes in a magnetic field of the outer magnet caused by rotation of the outer tone ring and configured to detect a rotational position of the outer portion, wherein a difference in rotational positions between the inner and outer portions is a twist angle that is proportional to the torque between the first and second components.

The torque sensor of the second aspect may include one or more of the previous embodiments and, optionally, that the inner tone ring and the outer tone ring are each made of a ferrous material.

The torque sensor of the second aspect may include one or more of the previous embodiments and, optionally, that a torsion disc comprises the inner portion, the first and second central portions, and the outer portion, and wherein the torsion disc has a maximum yield strength of at least approximately 1200 MPa.

A third aspect of the present disclosure is to provide a transmission for an electric motor-assisted vehicle, comprising a crankshaft rotatable about a rotational axis, wherein the crankshaft is configured to power a drive wheel to propel the vehicle; an electric motor configured to power the drive wheel to propel the vehicle; and a torque sensor having an inner portion engaged with the crankshaft; an outer portion engaged with the drive wheel; at least one central portion joining the inner and outer portions; and at least one sensor configured to detect a relative movement between the inner and outer portions, which is proportional to a torque applied to the crankshaft, and the electric motor is configured to transmit power to the drive wheel based on the torque to propel the vehicle.

The transmission of the third aspect may include, optionally, that the inner portion of the torque sensor has an annular shape that completely extends around the crankshaft, wherein the at least one central portion of the torque sensor is a first central portion and a second central portion each extending from the inner portion, and wherein the outer portion of the torque sensor comprises a first arm extending from the first central portion, wherein the first arm partially extends about the inner portion of the torque sensor; and a second arm extending from the second central portion, wherein the second arm partially extends about the inner portion of the torque sensor.

The transmission of the third aspect may include one or more of the previous embodiments and, optionally, an inner magnet associated with the inner portion of the torque sensor; and an outer magnet associated with the outer portion of the torque sensor, wherein the at least one sensor detects the inner and outer magnets to detect the relative movement between the inner and outer portions of the torque sensor.

The transmission of the third aspect may include one or more of the previous embodiments and, optionally, that the inner magnet is one of a set of inner magnets having alternating polarities and connected to the inner portion of the torque sensor, wherein the outer magnet is one of a set of outer magnets having alternating polarities and connected to the outer portion of the torque sensor, and wherein the at least one sensor comprises an inner Hall sensor configured to detect the set of inner magnets and a rotational position of the inner portion of the torque sensor; and an outer Hall sensor configured to detect the set of outer magnets and a rotational position of the outer portion of the torque sensor, wherein a difference in rotational positions between the inner and outer portions is the relative movement that is proportional to the torque applied to the crankshaft.

The transmission of the third aspect may include one or more of the previous embodiments and, optionally, that the inner portion of the torque sensor comprises an inner tone ring with alternating teeth and notches, wherein the outer portion of the torque sensor comprises an outer tone ring with alternating teeth and notches, and wherein the at least one sensor comprises an inner Hall sensor backed by the inner magnet, wherein the inner Hall sensor is configured to detect changes in a magnetic field of the inner magnet caused by rotation of the inner tone ring and configured to detect a rotational position of the inner portion; and an outer Hall sensor backed by the outer magnet, wherein the outer Hall sensor is configured to detect changes in a magnetic field of the outer magnet caused by rotation of the outer tone ring and configured to detect a rotational position of the outer portion, wherein a difference in rotational positions between the inner and outer portions is the relative movement that is proportional to the torque applied to the crankshaft.

The transmission of the third aspect may include one or more of the previous embodiments and, optionally, a controller in communication with the electric motor; and a battery in communication with the controller, wherein the controller is configured to receive an input signal from the at least one sensor, and wherein the controller is configured to cause the battery to supply electric power to the electric motor.

A fourth aspect of the present disclosure is to provide a torque sensor for detecting a torque between a first component and a second component, comprising a torsion disc having an inner portion configured to be engaged with the first component; and an outer portion joined to the inner portion, and the outer portion is configured to be engaged with the second component; a first set of alternating magnets associated with the inner portion of the torsion disc; a second set of alternating magnets associated with the outer portion of the torsion disc; and at least one sensor configured to detect polarities of the first and second sets of alternating magnets, which is used to determine the torque between the first component and the second component.

The torque sensor of the fourth aspect may include, optionally, that the inner portion has an annular shape configured to completely circumscribe the first component.

The torque sensor of the fourth aspect may include one or more of the previous embodiments and, optionally, that the outer portion of the torsion disc comprises a first arm partially extending about the inner portion; a second arm partially extending about the inner portion; and a third arm partially extending about the inner portion; wherein a distal end of the first arm, a distal end of the second arm, and a distal end of the third arm are each configured to be engaged to the second component.

The torque sensor of the fourth aspect may include one or more of the previous embodiments and, optionally, a first central portion joining a proximal end of the first arm to the inner portion; a second central portion joining a proximal end of the second arm to the inner portion; and a third central portion joining a proximal end of the third arm to the inner portion.

The torque sensor of the fourth aspect may include one or more of the previous embodiments and, optionally, that the first arm, the second arm, and the third arm are symmetric about a rotational axis of the torsion disc.

The torque sensor of the fourth aspect may include one or more of the previous embodiments and, optionally, that the first set of alternating magnets and the second set of alternating magnets are offset in an axial direction of the torsion disc, and the at least one sensor is offset from the first and second sets of alternating magnets in a radial direction of the torsion disc.

The torque sensor of the fourth aspect may include one or more of the previous embodiments and, optionally, that the first and second sets of alternating magnets have an equal number of magnets and are each arranged in a circular pattern with equal diameters.

The torque sensor of the fourth aspect may include one or more of the previous embodiments and, optionally, that a time offset between a time at which a transition in polarities of the first set of alternating magnets is detected by the at least one sensor and a time at which a transition in polarities of the second set of alternating magnets is detected by the at least one sensor, and the time offset is used to determine the torque between the first component and the second component.

A fifth aspect of the present disclosure is to provide a torque sensor for detecting a torque between a first component and a second component, comprising an inner portion configured to be engaged with the first component; a first magnet associated with the inner portion; an outer portion joined to the inner portion, and the outer portion is configured to be engaged with the second component, wherein the outer portion comprises a first arm partially extending about the inner portion; a second arm partially extending about the inner portion; and a third arm partially extending about the inner portion; a second magnet associated with the outer portion; and at least one sensor configured to detect polarities of the first and second magnets, which is used to determine the torque between the first and second components.

The torque sensor of the fifth aspect may include, optionally, that the first magnet is part of a set of first magnets with alternating polarities, and the second magnet is part of a set of second magnets with alternating polarities.

The torque sensor of the fifth aspect may include one or more of the previous embodiments and, optionally, that the at least one sensor comprises a first Hall sensor configured to detect a transition in polarities of the set of first magnets; and a second Hall sensor configured to detect a transition in polarities of the set of second magnets, wherein a time offset in detection times of the transitions in polarities of the sets of first and second magnets is used to determine the torque between the first and second components.

The torque sensor of the fifth aspect may include one or more of the previous embodiments and, optionally, that the sets of first and second magnets have an equal number of magnets and are each arranged in a circular pattern with equal diameters.

The torque sensor of the fifth aspect may include one or more of the previous embodiments and, optionally, that the first magnet and the second magnet are offset in an axial direction of the torque sensor, and the at least one sensor is offset from the first and second magnets in a radial direction of the torque sensor.

The torque sensor of the fifth aspect may include one or more of the previous embodiments and, optionally, that a torsion disc comprises the inner portion and the outer portion, and wherein the torsion disc has a maximum yield strength of at least approximately 1200 MPa.

A sixth aspect of the present disclosure is to provide a transmission for an electric motor-assisted vehicle, comprising a crankshaft rotatable about a rotational axis, wherein the crankshaft is configured to power a drive wheel to propel the electric motor-assisted vehicle; an electric motor configured to power the drive wheel to propel the electric motor-assisted vehicle; and a torque sensor having an inner portion engaged with the crankshaft; an outer portion engaged with the drive wheel; and at least one sensor configured to detect a relative rotational offset between the inner and outer portions, wherein the relative rotational offset is proportional to a torque applied to the crankshaft, and the electric motor is configured to transmit power to the drive wheel based on the torque to propel the electric motor-assisted vehicle.

The transmission of the sixth aspect may include, optionally, that the inner portion of the torque sensor has an annular shape that completely extends around the crankshaft, and wherein the outer portion of the torque sensor comprises a first arm partially extending about the inner portion of the torque sensor; a second arm partially extending about the inner portion of the torque sensor; and a third arm partially extending about the inner portion of the torque sensor; wherein a distal end of the first arm, a distal end of the second arm, and a distal end of the third arm are each configured to be engaged to the drive wheel.

The transmission of the sixth aspect may include one or more of the previous embodiments and, optionally, a set of alternating inner magnets associated with the inner portion of the torque sensor; and a set of alternating outer magnets associated with the outer portion of the torque sensor; wherein the at least one sensor detects polarities of the sets of alternating inner and outer magnets, which is used to detect the relative rotational offset between the inner and outer portions of the torque sensor.

The transmission of the sixth aspect may include one or more of the previous embodiments and, optionally, that the at least one sensor comprises an inner Hall sensor configured to detect a transition in polarities of the set of alternating inner magnets; and an outer Hall sensor configured to detect a transition in polarities of the set of alternating outer magnets, wherein a time offset in detection times of the transitions of polarities of the sets of inner and outer magnets is used to determine a difference in rotational positions between the inner and outer portions, which is the relative rotational offset that is proportional to the torque applied to the crankshaft.

The transmission of the sixth aspect may include one or more of the previous embodiments and, optionally, that the set of alternating inner magnets and the set of alternating outer magnets are offset in an axial direction of the torque sensor, and the at least one sensor is offset from the sets of alternating inner and outer magnets in a radial direction of the torque sensor.

The transmission of the sixth aspect may include one or more of the previous embodiments and, optionally, a controller in communication with the electric motor; and a battery in communication with the controller, wherein the controller is configured to receive an input signal from the at least one sensor, and wherein the controller is configured to cause the battery to supply electric power to the electric motor.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about”.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present invention. 1Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings. It is to be appreciated that any feature or aspect described herein can be claimed in combination with any other feature(s) or aspect(s) as described herein, regardless of whether the features or aspects come from the same described embodiment. Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

Those of skill in the art will recognize that the following description is merely illustrative of the principles of the invention, which may be applied in various ways to provide many different alternative embodiments. This description is made for illustrating the general principles of the teachings of this invention and is not meant to limit the inventive concepts disclosed herein.

The accompanying drawings, which are incorporated in and constitute a part of the specification, illustrate embodiments of the invention and together with the general description of the invention given above and the detailed description of the drawings given below, serve to explain the principles of the invention.

FIG. 1A is an exploded view of a torque sensor and parts of a transmission for an e-bike in accordance with an embodiment of the present disclosure;

FIG. 1B is a side elevation, cross-sectional view of the torque sensor taken along line B-B in FIG. 1A in accordance with an embodiment of the present disclosure;

FIG. 2A is a perspective view of a torsion disc in accordance with an embodiment of the present disclosure;

FIG. 2B is a perspective view of a further torsion disc with three arms in accordance with an embodiment of the present disclosure;

FIG. 3A is a perspective view of a further embodiment of a torque sensor in accordance with an embodiment of the present disclosure;

FIG. 3B is a top plan view of part of the torque sensor in FIG. 3A in accordance with an embodiment of the present disclosure;

FIG. 4 is a schematic view of a controller and other components in accordance with an embodiment of the present disclosure;

FIG. 5A is a perspective view of a torque sensor with the sets of magnets offset in an axial direction in accordance with an embodiment of the present disclosure;

FIG. 5B is a cross-sectional view of the torque sensor taken along line B-B in FIG. 5B in accordance with an embodiment of the present disclosure;

FIG. 6 is a perspective view of a torque sensor in FIG. 5A with an output wheel shown partially in phantom in accordance with an embodiment of the present disclosure;

FIG. 7 is a perspective view of the torque sensor in FIG. 5A with the output wheel removed in accordance with an embodiment of the present disclosure;

FIG. 8 is a perspective view of the output wheel of the torque sensor in FIG. 5A in accordance with an embodiment of the present disclosure;

FIG. 9A is a perspective view of a torque sensor in accordance with an embodiment of the present disclosure;

FIG. 9B is a cross-sectional view of the torque sensor taken along line B-B in FIG. 9A in accordance with an embodiment of the present disclosure;

FIG. 10A is a detailed perspective view of the sensor assembly of the torque sensor in FIG. 9A in accordance with an embodiment of the present disclosure; and

FIG. 10B is a cross-sectional view of the sensor assembly and torque sensor taken along line B-B in FIG. 10A in accordance with an embodiment of the present disclosure.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.
2 Transmission
4 Crankshaft
6 Wheel
8 Torque Sensor
10 Torsion Disc
12 Clutch
14 Pin
16 Set of Inner Magnets
18 Set of Outer Magnets
20 Inner Sensor
22 Outer Sensor
24 Axial Direction
26 Radial Direction
28 Inner Portion of Torsion Disc
29 Outer Portion of Torsion Disc
30 First Central Portion
32 First Arm
33 Distal End of First Arm
34a, 34b First Connection Aperture
36 First Gap
38 Second Central Portion
40 Second Arm
41 Distal End of Second Arm
42a, 42b Second Connection Aperture
43 Third Arm
44 Second Gap
46a, 46b Tooth
48a, 48b Notch
50 Magnet
52 Input
54 Controller
56 Battery
58 Motor
60 Center Aperture of Torsion Disc
62 Thickness or Width of First Arm (in Radial Direction)
64 First Gap (Distance between Torsion Disc Inner Portion and First Arm)
66 Thickness or Width of Second Arm (in Radial Direction)
68 Second Gap (Distance between Torsion Disc Inner Portion and Second Arm)
70 Circular Line (Portion thereof) on First Arm
72 Circular Line (Portion thereof) on Second Arm
74 Inner Tone Ring
76 Outer Tone Ring
80 Transmission
82 Crankshaft
83a Axial Direction
83b Radial Direction
84 Wheel
86 Torsion Disc
88 Crank Plate
90 Sensor Assembly
92 Crank Sensor
94 Wheel Sensor
96 Crank Magnet Set
97 Crank Space
98 Wheel Magnet Set
99 Wheel Space
100 North (Crank)
102 South (Crank)
104 North (Wheel)
106 South (Wheel)
108 Inner Portion
109 Outer Portion
110a, 110b Fastener Projection
110c Fastener Projection
111a, 111b Central Portion
111c Central Portion
112a, 112b Arm
112c Arm
114a, 114b Distal End
114c Distal End
116a, 116b Distal Pin
116c Distal Pin
118a, 118b Brace Roller
118c, 118d Brace Roller
118e, 118f Brace Roller
120a, 120b Brace Pin
120c, 120d Brace Pin
120e, 120f Brace Pin
122a, 122b Distal Recess
122c Distal Recess
124a, 124b Brace Recess
124c, 124d Brace Recess
124e, 124f Brace Recess
126 Torque Sensor
127a Axial Direction
127b Radial Direction
128 Inner Component
130 Outer Component
131 Torsion Disc
132 Inner Magnet Set
134 Outer Magnet Set
136 Sensor Assembly
138 Inner Plate
140 Outer Plate
142 Inner Sensor
144 Outer Sensor
146 Inner Space
148 Outer Space

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment of the torque sensor since describing every possible embodiment would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present invention. Thus, dimensions, aspects, and features of one embodiment of the torque sensor can be combined with dimensions, aspects, and features of another embodiment of the torque sensor to create the claimed embodiment. “Sets” and “pluralities” of magnets are generally interchangeably. Similarly, “inner”, “outer”, “first”, “second”, “crank”, and “wheel” magnets are described to distinguish between multiple sets of magnets and can be interchangeable.

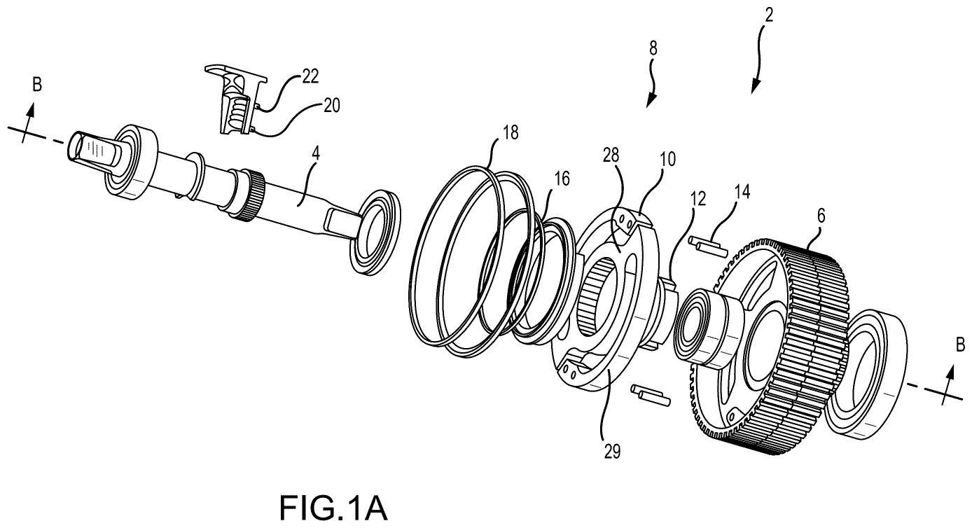

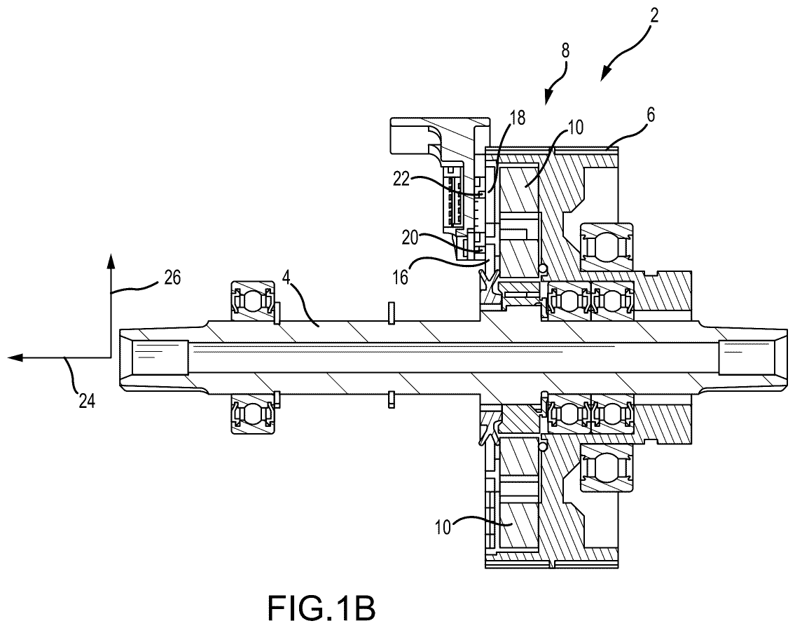

FIG. 1A is an exploded view of part of a transmission 2 as well as an embodiment of a torque sensor 8, which detects a torque applied to a first component such as a crankshaft 4 relative to a second component such as a wheel 6. In some embodiments, the wheel 6 serves as a drive wheel that turns a chain, a rear hub, and a rear wheel to propel a bicycle, or the wheel 6 is otherwise engaged with the drive wheel. FIG. 1B is a cross-sectional view of these components taken along line B-B in FIG. 1A.

For an e-bike, the transmission 2 interfaces the relatively higher speed/lower torque rotation of an electric motor with the relatively lower speed/higher torque rotation of the drive wheel to selectively assist an effort of a user, for instance, when the user is pedaling the bicycle up a hill. The torque sensor 8 detects the effort of the user applied to the crankshaft 4 in terms of torque relative to the drive wheel, and information from the torque sensor 8 can indicate when the electric motor should power the transmission and the drive wheel to assist the user by reducing the effort required by the user. While this embodiment is described with respect to a transmission for an e-bike, it will be appreciated that the present disclosure encompasses embodiments of the torque sensor 8 that detect torque applied to any component of a bicycle, with or without a transmission, or any other rotating device or system that benefits from the detection of torque.

As described herein, a torsion disc 10 of the torque sensor 8 has an inner portion 28 engaged with the crankshaft 4 and has an outer portion 29 engaged with the wheel 6. In some embodiments, the inner portion 28 has an annular shape configured to completely circumscribe the crankshaft 4. A one-way bearing or pawl clutch 12 engages the inner portion 28 of the torsion disc 10 with the crankshaft 4 such that only one direction of rotation of the crankshaft 4 is transmitted to the torsion disc 10 and ultimately the wheel 6, which is a drive wheel in some embodiments. Accordingly, in the context of a bicycle, the pawl clutch 12 turns the drive wheel when a user pedals, but the pawl clutch 12 does not turn the drive wheel when the user stops pedaling. In other embodiments, the inner portion 28 is directly connected to the crankshaft 4. The outer portion 29 is engaged with the wheel 6 with multiple pins 14 in a manner described in further detail herein. When a torque is applied to the crankshaft 4, the torsion disc 10 deforms and the inner portion 28 rotates relative to the outer portion 29. The difference in rotational positions of the inner and outer portions is proportional to the torque. To detect these rotational positions, a set of inner magnets 16 with alternating polarities is engaged with the inner portion 28 of the torsion disc 10, and a set of outer magnets 18 with alternating polarities is engaged with the outer portion 29 of the torsion disc 10.

An inner sensor 20 and an outer sensor 22 detect polarities of the sets of magnets 16, 18 as the magnets rotate by the sensors 20, 22 and vary the magnetic field proximate to the sensors 20, 22. Specifically, the sets of magnets 16, 18 have alternating north/south polarities, and the sensors 20, 22 are in a fixed position relative to the rotating sets of magnets 16, 18 connected to the inner 28 and outer 29 portions of the torsion disc 10, respectively. Accordingly, from the perspective of the inner sensor 20, the alternating inner magnets 16 pass by with a north polarity, then a south polarity, then a north polarity, etc. Similarly, from the perspective of the outer sensor 22, the alternating outer magnets 18 pass by with a north polarity, then a south polarity,

then a north polarity, etc.

The transition between polarities as detected by the sensors 20, 22 is used to determine the relative rotational positions or twist angle between the inner and outer portions 28, 29, the deformation of the torsion disc 10 and, thus, the torque. In a simplified example to demonstrate this principle, a transition between two inner magnets with alternating polarities is associated with a transition between two outer magnets with alternating polarities. When no torque is

applied to the torsion disc 10, there is a first rotational offset between sets of magnets 16, 18 and, thus, a first time offset between the time at which the inner sensor 20 detects the transition in polarities between the two inner magnets and the time at which the outer sensor 22 detects the transition in polarities between the two outer magnets. In a non-limiting example, the first rotational offset is 1 degree and the first time offset is 1 ms. Then, when a torque is applied to the torsion disc 10, there is a second rotational offset and a second time offset. In this non-limiting example, the second rotational offset increases to 4 degrees, and the second time offset increases to 4 ms. The time offsets, in particular the difference in first and second time offsets, is discerned from the readings from the sensors 20, 22, and this information is used to determine the rotational offset between the inner and outer portions 28, 29, the deformation of the torsion disc 10 and thus the torque.

In addition, in some embodiments, the torque sensor 8 is calibrated to accommodate the motion of the crankshaft 4 itself. The motion of the crankshaft 4 impacts the relative rotational displacement between the sets of magnets 16, 18 and, thus, between inner 28 and outer 29 portions of the torsion disc 10. In other words, a crankshaft 4 that rotates quickly may cause the sensors 20, 22 to detect a twist angle that is different than a twist angle detected by the sensors 20, 22 when the crankshaft 4 rotates slowly. To calibrate the torque sensor 8, readings are taken when the crankshaft 4 rotates at a known speed and under known forces to understand the effect of the motion of the crankshaft 4. Once the effect is characterized, a controller, as discussed herein, can account for the effect that the motion of the crankshaft 4 has on the readings measured by the sensors 20, 22, and the actual relative rotational displacement or twist angle between inner 28 and outer 29 portions of the torsion disc 10 can be discerned.

In an exemplary embodiment, the torsion disc 10 is configured to detect a maximum torque of 120 Nm. The twist angle between the inner 28 and outer 29 portions of the torsion disc 10 can be approximately 1 degree in response to 120 Nm of torque, in some embodiments, with a linear relationship between the twist angle and torque. In various embodiments, the twist angle of the inner 28 and outer 29 portions of the torsion disc 10 can be approximately 2-4 degrees in response to 120 Nm of torque. Moreover, the maximum stress experienced by the torsion disc 10 is less than 1200 MPa to ensure that deformation of the torsion disc 10 is elastic in nature.

It will be appreciated that the present disclosure encompasses embodiments of the torque sensor 8 where different amounts of relative movement or twist angles between the inner 28 and outer 29 portions of the torsion disc 10 correspond to different torque readings depending on the construction of the torsion disc 10, material selections, etc. Moreover, the relative movement between the inner 28 and outer 29 portions of the torsion disc 10 can have a non-linear relationship with the torque. The sensors 20, 22 can transmit information to the controller, which is assessed by the controller to determine if a user needs assistance. The term “torque sensor” can include the combination of the sensors 20, 22, the torsion disc 10, the sets of magnets 16, 18, and/or other related components.

Also shown in FIG. 1B are the axial direction 24 and the radial direction 26. A component such as the crankshaft 4, the torsion disc 10, other components of the torque sensor 8, or the torque sensor 8 generally rotate about a rotational axis that extends in the axial direction 24. In other words, the axial direction 24 is parallel to the rotational axis. The radial direction 26 extends perpendicular to the axial direction 24 and 360 degrees around the axial direction 24. As described herein, the space around the crankshaft 4 in the axial direction 24 can be valuable or necessary to many different components, and in some embodiments, the torsion disc 10 of the torque sensor 8 extends farther in the radial direction 26 than the axial direction 24 to preserve some of the valuable space along the crankshaft 4.

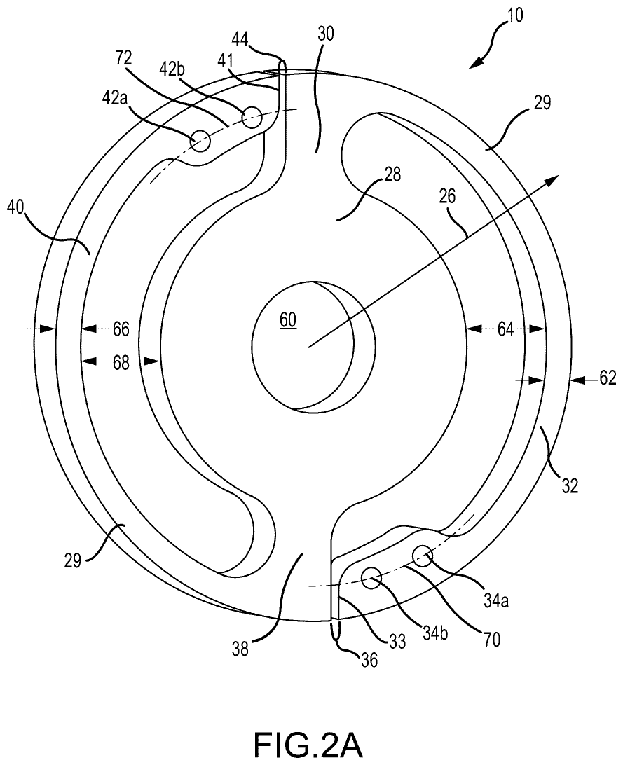

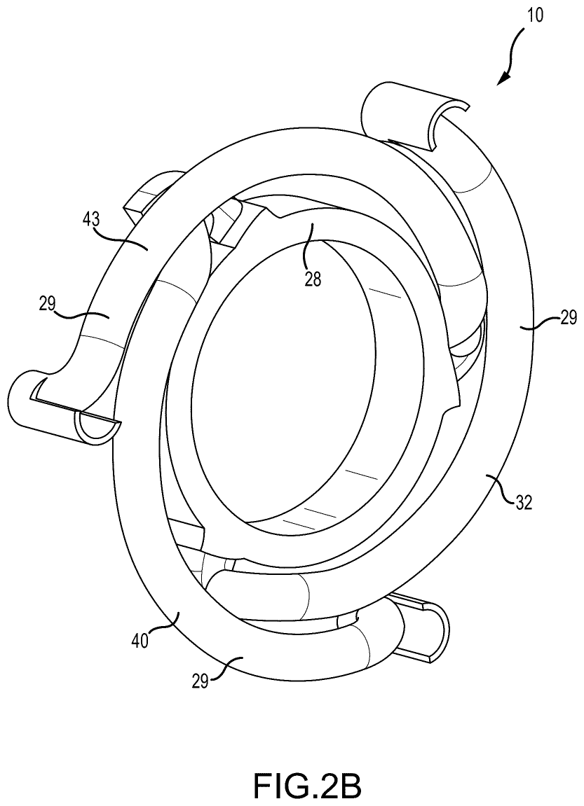

FIG. 2A is a perspective view of a torsion disc 10 of the torque sensor 8. The torsion disc 10 has an inner portion 28 positioned about the crankshaft and extends around the entire perimeter and/or circumference of the crankshaft. The torsion disc 10 has a center aperture 60 with a diameter and circumference sized and shaped to fit around and engage the crankshaft. A

first central portion 30 and a second central portion 38 of the torsion disc 10 extend outward from the inner portion 28 in the radial direction 26. While two central portions 30, 38 are depicted in FIG. 2A, it will be appreciated that the torsion disc 10 can have more or fewer than two central portions 30, 38.

Next, a first arm 32 extends from the first central portion 30, and a second arm 40 extends from the second central portion 38. The first arm 32 and the second arm 40 form the outer portion 29 of the torsion disc 10, and the first arm 32 and the second arm 40 are symmetric about the rotational axis of the torsion disc 10. In some embodiments, the central portions 30, 38 can be described as part of the respective arms 32, 40 where the central portions 30, 38 join proximal ends of the respective arms 32, 40 to the inner portion 28. The first arm 32 extends in an arc about the inner portion 28 and is offset from the inner portion 28 by a first gap 64. A distal end 33 of the first arm 32 is located proximate to the second central portion 38, and the first arm 32 has a generally consistent thickness or width 62 in the radial direction until the portion proximate the distal end 33, which is wider or thicker in the radial direction 26 in part to accommodate one or more apertures 34a, 34b.

The various aspects of the first arm 32, and the second arm 40 as discussed below, serve several functions. The first gap 64 is greater than zero to allow the outer portion 29 to rotate relative to the inner portion 28, but the first gap 64 can be sized to accommodate the particular application of the torque sensor. When the torque sensor detects a torque between a crankshaft and a drive wheel, the first gap 64 may be larger to bridge the distance between the crankshaft and the drive wheel in the radial direction 26. When the torque sensor detects a torque between concentric shafts, the first gap 64 may be smaller so that the torque sensor, specifically the torsion disc 10 can fit between the shafts.

Moreover, these various aspects of the first arm 32 also dictate the deformation characteristics of the torsion disc 10. For example, the thickness or width 62 of the first arm 32 can be larger, necessarily reducing the size of the first gap 64, so that the torsion disc 10 deforms less when subjected to a given torque. In this sense, the torsion disc 10 is stiffer to handle higher torques. Conversely, the thickness or width 62 of the first arm 32 can be smaller, allowing the first gap 64 to increase, to accommodate a smaller torque. This increase in the first gap 64 also eliminates unnecessary mass from the torsion disc 10, which can be beneficial in some applications such as a bicycle application where lighter weights are preferable.

The first arm 32 has two apertures 34a, 34b near the distal end 33 through which two pins engage the first arm 32 with the wheel. With multiple pins through multiple apertures 34a, 34b arranged on a circular line 70 (shown in part) centered on a rotational axis, deformation of the first arm 32 occurs along the first arm 32, about the rotational axis, and is translated to the rotational positions of the inner 28 and outer 29 portions of the torsion disc 10 for more accurate torque readings. The circular line 70 has a constant distance from the rotational axis of the torsion disc 10 in the radial direction 26. Alternatively or additionally, a single, non-circular pin (e.g., rectangular or oval) that extends along the circular line 70 can serve the same function as multiple pins. As will be appreciated, fewer or more than two apertures 34a, 34b and fewer or more than two pins can be used. Moreover, the apertures 34a, 34b can have different shapes, i.e., other than circular. The apertures 34a, 34b can also be closer or farther apart from one another.

In some embodiments, the first arm 32 has a single aperture 34a through which a single pin along with a rotary bearing element engage the first arm 32 with the wheel. In this embodiment, deformation of the first arm 32 in response to a torque causes the first arm 32 to bow outward and rotate relative to the wheel. This allows more rotation of the outer portion 29 relative to the inner portion 28 for a given torque, which results in less stress on the torsion disc 10 in the area of the aperture 34a as well as a different torque versus rotation relationship.

The distal end 33 of the first arm 32 is offset from the second central portion 38 by a first gap 36. When a user applies a torque to the crankshaft, the torsion disc 10 deforms such that the first gap 36 between the distal end 33 of the first arm 32 and the second central portion 38 changes in size. In this embodiment, the first gap 36 can only get smaller in the presence of a torque since the one-way bearing or pawl clutch 12 only permits one direction of rotation to be transmitted to the torsion disc 10. The first gap 36 also establishes a maximum twist angle between the inner portion 28 and the first arm 32 and a maximum detectable torque of the torque sensor. When a large torque is applied, the torsion disc 10 deforms so much that distal end 33 of the first arm 32 closes the first gap 36 and contacts the second central portion 38, and the first arm 32 can move no further around the rotational axis. Therefore, any further torque applied beyond this point does not further displace the inner 28 and outer 29 portions relative to each other, and the inner 28 and outer 29 portions are at a maximum twist angle relative to each other. This also establishes the maximum torque detectable by the torque sensor since the torsion disc 10 cannot further deform. This maximum twist angle and maximum detectable torque prevent the torsion disc 10 from deforming beyond an elastic range of deformation to preserve the longevity and operability of the torsion disc 10 and the overall torque sensor.

In the depicted embodiment, the second arm 40 is arranged like the first arm 32. The second arm 40 extends in an arc about the inner portion 28 and is offset from the inner portion 28 by a second gap 68, and two apertures 42a, 42b are located near a distal end 41 of the second arm 40 to receive pins that engage the second arm 40 with the wheel. The second arm 40 extends in an arc about the inner portion 28, and the distal end 41 of the second arm 40 is located proximate to the first central portion 30. The second arm 40 has a generally consistent thickness or width 66 in the radial direction until the portion proximate the distal end 41, which is wider or thicker in the radial direction 26 in part to accommodate one or more apertures 42a, 42b.

Like the first arm 32, the various aspects of the second arm 40 serve several functions. The second gap 68 is greater than zero to allow the outer portion 29 to rotate relative to the inner portion 28, but the second gap 68 can be sized to accommodate the particular application of the torque sensor. When the torque sensor detects a torque between a crankshaft and a drive wheel, the second gap 68 may be larger to bridge the distance between the crankshaft and the drive wheel in the radial direction 26. When the torque sensor detects a torque between concentric shafts, the second gap 68 may be smaller so that the torque sensor, specifically the torsion disc 10 can fit between the shafts.

Moreover, these various aspects of the second arm 40 also dictate the deformation characteristics of the torsion disc 10. For example, the thickness or width 66 of the second arm 40 can be larger, necessarily reducing the size of the second gap 68, so that the torsion disc 10 deforms less when subjected to a given torque. In this sense, the torsion disc 10 is stiffer to handle higher torques. Conversely, the thickness or width 66 of the second arm 40 can be smaller, allowing the second gap 68 to increase, to accommodate a smaller torque. This increase in the second gap 68 also eliminates unnecessary mass from the torsion disc 10, which can be beneficial in some applications such as a bicycle application where lighter weights are preferable.

The second arm 40 has two apertures 42a, 42b near the distal end 41 through which two pins engage the second arm 40 with the wheel. With multiple pins through multiple apertures 42a, 42b arranged on a circular line 72 (shown in part) centered on a rotational axis, deformation of the second arm 40 occurs along the second arm 40, about the rotational axis, and is translated to the rotational positions of the inner 28 and outer 29 portions of the torsion disc 10 for more accurate torque readings. The circular line 72 has a constant distance from the torsion disc 10 center point in the radial direction 26. Alternatively or additionally, a single, non-circular pin (for example, rectangular or oval) that extends along the circular line 72 can serve the same function as multiple pins. As will be appreciated fewer or more than two apertures 42a, 42b and fewer or more than two pins can be used. Moreover, the apertures 42a, 42b can have different shapes, i.e., other than circular. The apertures 42a, 42b can also be closer or farther apart from one another. Further still, the second arm 40 can have a single aperture 42a and a single pin with a rotary bearing element as described above with respect to the first arm 32.

The distal end 41 of the second arm 40 is offset from the first central portion 30 by a second gap 44 that can establish the maximum twist angle and the maximum detectable torque like the first gap 36 between the second central portion 38 and the distal end 33 of the first arm 32. It will be appreciated that while two arms 32, 40 are depicted, the present disclosure encompasses embodiments of the torsion disc 10 with more than two arms 32, 40.

In some embodiments, the maximum twist angle or relative displacement between the inner portion 28 and the arms 32, 40 is approximately 1.4 degrees. In some embodiments, the maximum twist angle is approximately 3 degrees. Moreover, there is a generally linear relationship between the twist angle and the torque applied to the crankshaft. In some embodiments, 1 degree of twist angle corresponds to approximately 120 Nm of torque. However, the relationship between twist angle and torque could be non-linear. The thickness dimension of the torsion disc 10 in the axial direction can be between approximately 5 mm and 15 mm. In some embodiments, the thickness of the torsion disc 10 in the axial direction is approximately 9 mm, which is less than the dimension of the torsion disc 10 in the radial direction 26. Finally, the torsion disc 10 is made from a material that has a sufficiently high maximum yield strength to ensure that deformation of the torsion disc 10 remains elastic in nature. In some embodiments, the torsion disc 10 is made from a material with a maximum yield strength of greater than 1200 MPa. In various embodiments, the torsion disc 10 is made from a material with a maximum yield strength of approximately 1580 MPa.

FIG. 2B shows a torsion disc 10 with three arms (a first arm 32, a second arm 40, and a third arm 43) that form the outer portion 29 of the torsion disc 10. In this embodiment, the arms 32, 40, 43 are symmetrically arranged about an axis of rotation of the torsion disc 10, and each arm 32, 40, 43 extends around approximately half of the inner portion 28 of the torsion disc 10. With this arrangement, the relatively longer arms 32, 40, 43 can deform in response to a given torque with less stress on the arms 32, 40, 43. This keeps deformation of the torsion disc 10 within an elastic range of deformation to maintain the longevity of the torsion disc 10 and the accuracy and precision of readings from the overall torque sensor over many cycles. The arrangement of arms 32, 40, 43 shown in FIG. 2B also allows for a more compact torsion disc 10 and torque sensor, and the arms 32, 40, 43 can be made from a spring wire with high tensile strength for easy and cheap manufacturing.

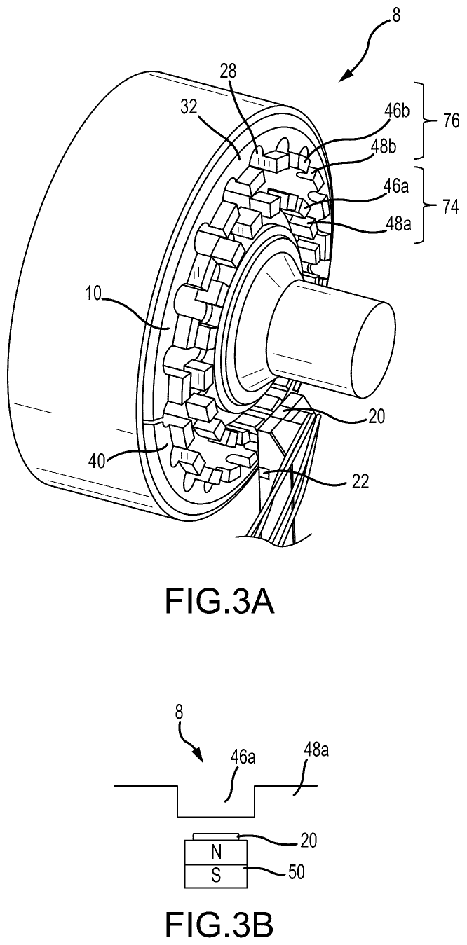

FIGS. 3A and 3B show another embodiment of a torque sensor 8. In this embodiment, the torque sensor 8 relies on stationary magnets instead of moving magnets like the torque sensor in FIGS. 1A and 1B. The torque sensor 8 has sensors 20, 22, a torsion disc 10 with an inner portion 28 and arms 32, 40, and inner 74 and outer 76 tone rings. The inner tone ring 74 is part of the inner portion 28 or is otherwise engaged with the inner portion 28 and comprises alternating teeth 46a and notches 48a. Similarly, the outer tone ring 76 is part of the arms 32, 40 or is otherwise engaged with the arms 32, 40 and comprises alternating teeth 46 b and notches 48b.

As shown in FIG. 3B, the inner sensor 20, which is a Hall sensor in this embodiment, is backed by a magnet 50. Thus, with the inner tone ring 74 made from a ferrous metal, the inner sensor 20 detects a change in magnetic field produced by the magnet 50 as the alternating teeth 46a and notches 48a move by the magnet 50. Similarly, the outer sensor 22 detects a change in magnetic field produced by its respective magnet as the alternating teeth 46 b and notches 48b move by that respective magnet. The information conveyed to part of the torque sensor 8 or a controller receiving information from the torque sensor 8 can appear as a “stepped” signal where one constant portion of the step is when a tooth 46a, 46b is closest to the sensor 20, 22, and another constant portion of the step is when a notch 48a, 48b is closest to the sensor 20, 22. Rising or descending edges join the constant portions of the steps, and the time measured between edges can be used to determine a rate of rotation of the crankshaft and/or the output wheel. For instance, the rate of rotation of the inner tone ring 74 corresponds to the rate of rotation of the crankshaft, and the rate of rotation of the outer tone ring 76 corresponds to the rate of rotation of the output wheel. Thus, the torque sensor 8 can further function like a cadence sensor, and this ability applies to other embodiments of the torque sensor 8 described herein.

Characteristics of this information such as the relative timing of such signals between sensors, the frequency of such signals, etc. can be used to determine the relative positioning between the inner portion 28 of the torsion disc 10 and the outer arms 32, 40 (including the third arm if there is a third arm), the overall speed of rotation of the torsion disc 10, etc. A change in relative positioning corresponds to a twist angle and, thus, a torque applied to a crankshaft relative to a wheel.

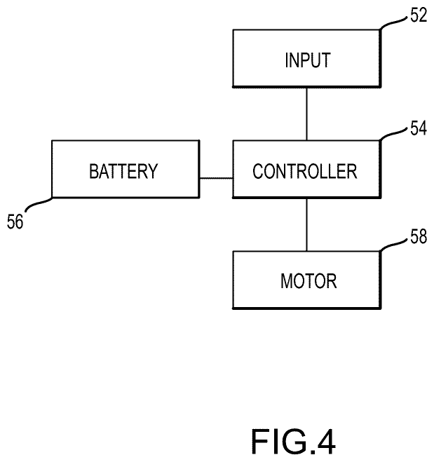

FIG. 4 shows a schematic view of the controller 54 and related components in the context of a transmission for an e-bike. Embodiments of the controller 54 and the system shown in FIG. 4 can be applied to any torque sensor encompassed by the present disclosure. The controller 54 coordinates various components to selectively power the electric motor 58, which transmits power through the transmission to a drive wheel to assist a user riding the vehicle or e-bike. As part of this coordination, the controller 54 can selectively allow a battery 56 to supply the electric motor 58 with electric power.

One or more input devices 52 can transmit information in one or more input signals to the controller 54 where the controller 54 can take further action, or not, based on the one or more input signals. A torque sensor that detects a torque applied to the crankshaft relative to the drive wheel can serve as an input device 52 to the controller 54. Specifically, information such as magnet polarity information from the torque sensor can be transmitted to the controller 54 as an input signal, or the torque sensor itself can determine torque readings, speed data, etc., which is then transmitted to the controller 54 as the input signal. In one example, the controller 54 determines that a torque reading is above a predetermined threshold, then the controller 54 permits electric power to flow from the battery 56 to the electric motor 58 to assist a user.

Other possible input devices 52 may include a cadence sensor, a moisture sensor, etc. that transmit an input signal to the controller 54. Further still, a user can engage some input devices 52 to transmit an input signal to the controller 54. The input device 52 can be, for instance, an assist level selector like a shifter or a button, a pedal assist setting, a throttle, etc. These input devices 52 are exemplary in nature.

The controller 54 can analyze information in the input signal from the torque sensor along with any other input signals. In one example, a user has engaged an input device 52 to select an assist level of 10 out of 10 (i.e., the maximum), and the input device 52 transmits a first input signal to the controller 54. Moreover, an input device 52 that is a torque sensor transmits a second input signal to the controller 54, and an input device 52 that is a moisture sensor transmits a third input signal to the controller 54. The resulting determination of the controller 54 can be based on torque, cadence, user control, moisture, etc. For instance, the controller 54 assesses that the moisture reading is below a threshold level where excessive moisture would be dangerous, the torque reading is above a threshold level where the user needs assistance, and the assist level of 10 is associated with a predetermined amperage and, thus, based on these input signals, the controller 54 allows electric power to flow from the battery 56 to the electric motor 58 at the predetermined amperage to assist a user a predetermined amount.

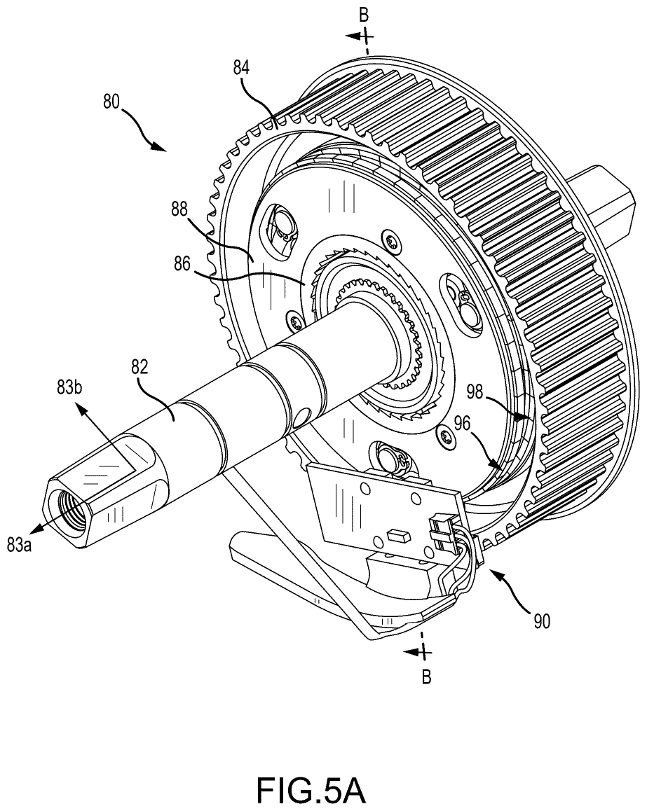

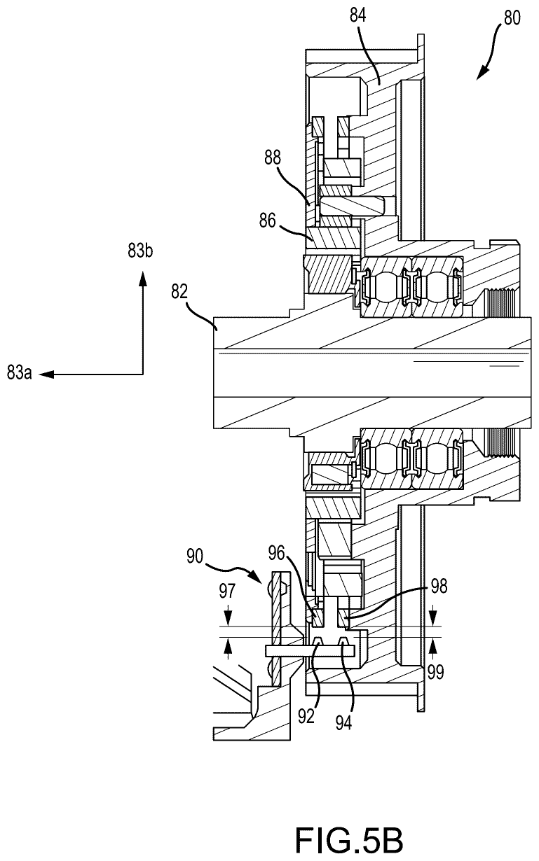

FIGS. 5A and 5B show a torque sensor 80 where the sets of magnets 96, 98 are offset in an axial direction 83a of the crankshaft 82, and the sensor assembly 90 is offset from the sets of magnets 96, 98 in a radial direction 83b of the crankshaft 82. Though described in reference to the crankshaft 82, the axial and radial directions, 83a, 83b can be described in reference to the overall torque sensor 80, components of the torque sensor 80, a torsion disc 86, etc. With wear and tear on the crankshaft 82, the torque sensor 80, and the vehicle or other device to which the torque sensor 80 is applied, any resulting distortion is less in the radial direction 83b than the axial direction 83a. For example, if the output wheel 84 and/or components of the torque sensor 80 are tilted away from a perpendicular arrangement with the crankshaft 82, then the spatial variation between sets of magnets 96, 98 and the sensor assembly 90 can be less pronounced with the radial offset shown in FIGS. 5A and 5B than other arrangements between sets of magnets 96, 98 and the sensor assembly 90. Thus, runout is less, and the need for post-processing of signals from the signal assembly 90 is less likely.

Furthermore, each set of magnets 96, 98 can be made the identically, with the same size, the same shape and angular offset between “north” and “south” oriented magnets. Even more, when sets of magnets are made with the same manufacturing process, same molds, etc., any small idiosyncrasies are repeated the same way in both sets of magnets 96, 98. In a non-limiting example, a small imperfection at the transition between two magnets may be repeated between both sets of magnets 96, 98. Thus, the orientations of the sets of magnets 96, 98 can be tracked and the sets of magnets 96, 98 are installed the same way such that the transition between two magnets of the inner set 96 corresponds to the transition between magnets of the outer set 98, even if the sets of magnets 96, 98 are initially installed with a small rotational offset. When these transitions of polarities are detected by sensors, the small imperfections are likely to cancel each other out and reduce error in the readings detected by the sensor assembly 90.

As shown in FIG. 5A, the crankshaft 82 serves as an input to the torque sensor 80, and a wheel 84 serves as an output of the torque sensor 80. This torque sensor 80 can be used in, for example, a bicycle to determine the torque that a user applies to the crankshaft 82 relative to the wheel 84, and the torque reading can be used for subsequent actions such as changing a gear or speed ratio of a transmission to better match the effort of the user. However, it will be appreciated that the torque sensor 80 can be used in any number of applications. Also shown, in FIG. 5A is the torsion disc 86, a crank plate 88 that extends from part of the torsion disc 86, and a sensor assembly 90. Generally, when a user applies torque to the crankshaft 82, torque is transmitted through the torsion disc 86, and to the output wheel 84, which then drives a chain or belt to propel a vehicle such as a bicycle. When transmitting torque, the torsion disc 86 deforms and causes a rotational offset between sets of magnets 96, 98 that is proportional to the torque.

FIG. 5B shows a set of crank magnets 96 positioned at an end of the crank plate 88, and a set of wheel magnets 98 positioned on the wheel 84. In some embodiments, these sets of magnets 96, 98 are identical to reduce runout and provide other benefits described herein. In particular, the sensor assembly 90 has a crank sensor 92 that detects the alternating polarities of the magnets of the set of crank magnets 96, and the sensor assembly 90 has a wheel sensor 94 that detects the alternating polarities of the magnets of the set of wheel magnets 98. A crank space 97 is between the crank sensor 92 and the set of crank magnets 96, and a wheel space 99 is between the wheel sensor 94 and the set of wheel magnets 98. These spaces 97, 99, due to their radial orientation between sensors 92, 94 and sets of magnets 96, 98, are less sensitive to variations in relative positions among components of the torque sensor 80.

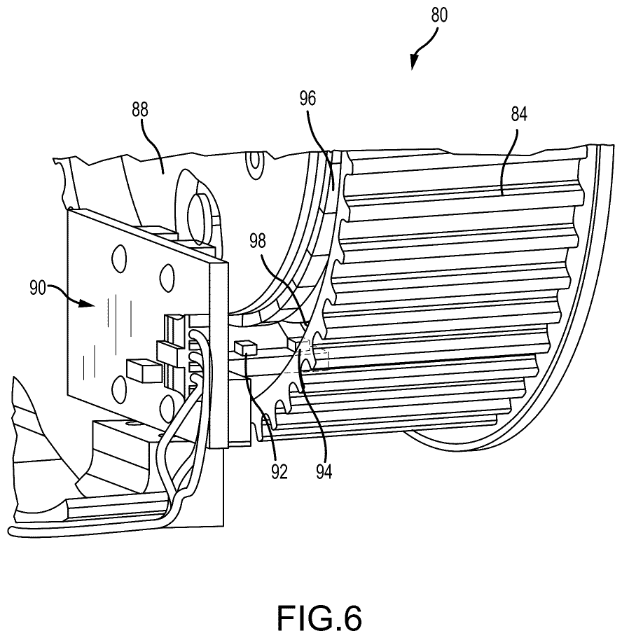

FIG. 6 is a perspective view of the torque sensor 80 with the wheel 84 shown partially in phantom. The sensors 92, 94 can be any sensor described herein, including a Hall sensor that detects the polarity of a magnet and detects the alternating polarities of magnets as the magnets pass by the sensor. As described elsewhere herein, each of the crank sensor 92 and the wheel sensor 94 will detect transitions in polarities from magnets in the respective set of magnets 96, 98. In other words, a time at which the crank sensor 92 detects a transition in polarities of magnets in the set of crank magnets 96 is compared to the time at which the wheel sensor 94 detects a corresponding transition in polarities of magnets in the set of wheel magnets 98 to determine a time offset. When torque is applied and the torsion disc is deformed as described herein, then the time offset increases and is proportional to the torque applied to the torsion disc.

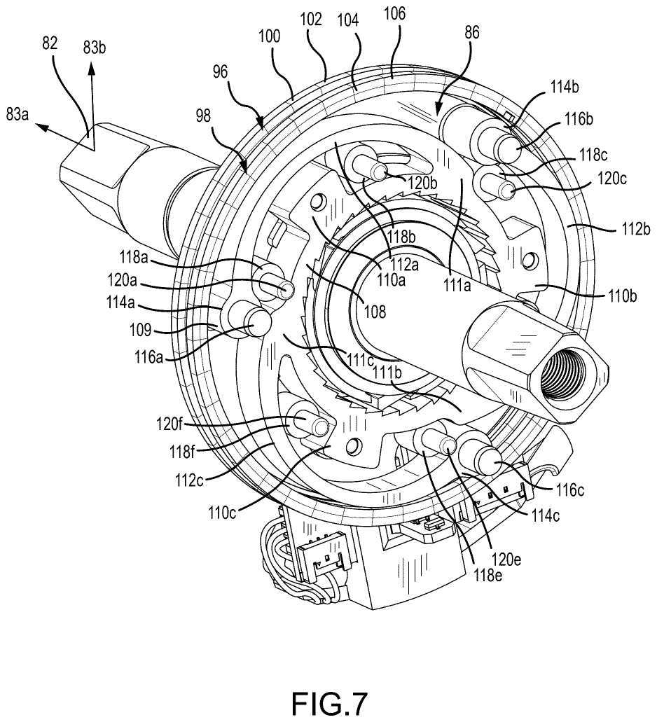

FIG. 7 is a perspective view of the torque sensor without the wheel and, in particular, showing the torsion disc 86. The torsion disc 86 has a generally circular-shaped inner portion 108 positioned about the crankshaft 82. When a user applies torque to the crankshaft 82, the crankshaft 82 applies the torque to the inner portion 108. As shown, the crankshaft 82 can engage the inner portion 108 with a pawl system such that only one direction of rotation of the crankshaft 82 is transmitted to the inner portion 108 of the torsion disc 86. Three fastener projections 110a-110c extend radially outward from the inner portion 108, and the crank plate (88 in FIG. 6) is fastened to the fastener projections 110a-110c such that no deformation of the torsion disc 86 is transferred to the fastener projections 110a-110c, the crank plate, or the set of crank magnets 96. Thus, the set of crank magnets 96 remains rotationally fixed relative to the crankshaft 82, when the crankshaft 82 is transmitting torque.

The torsion disc 86 in FIG. 7 has three projections 110a-110c evenly arrayed about the crankshaft 82. It will be appreciated that in other embodiments there are more or fewer than three projections 110a-110c. In some embodiments, the crank plate is affixed to the projections 110a-110c by another type of connection than a fastener such as an adhesive or interference fit. Further still, in some embodiments, the inner portion 108 and the crank plate are a common structure without any fastener or type of connection.

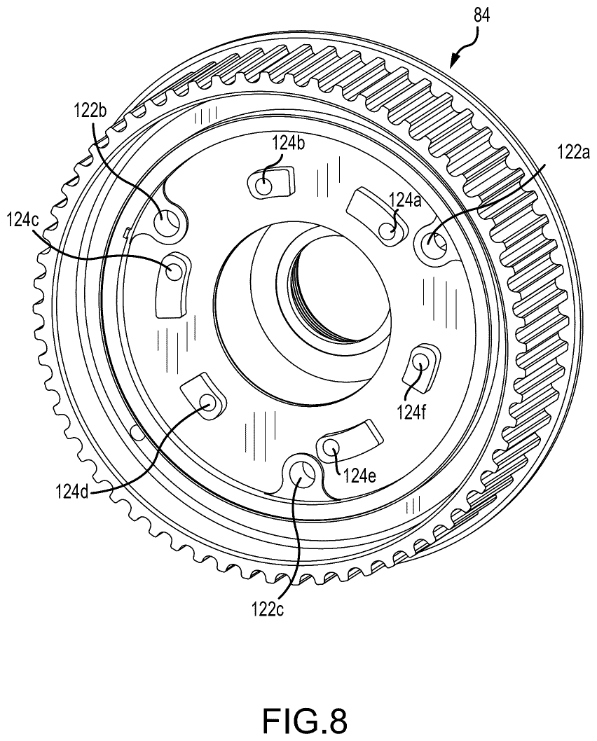

Three arms 112a-112c extend from the inner portion 108, and the arms 112a-112c serve as the outer portion 109 of the torsion disc 86. Each arm 112a-112c is positioned between adjacent projections 110a-110c. Moreover, each arm 112a-112c wraps around part of the inner portion 108 and terminates in a respective distal end 114a-114c with a respective distal pin 116a-116c. These distal pins 116a-116c are joined to the wheel (84 in FIG. 8) to transmit torque from the outer portion 109 of the torsion disc 86 to the wheel. As torque is applied to the crankshaft 82, torque is transmitted through the inner portion 108 of the torsion disc 86 and into the arms 112a-112c which will deform in response to the torque. The use of distal pins 116a-116c accommodates deformation of the arms 112a-112c. When the arms 112a-112c deform, the wheel and the set of wheel magnets 98 will rotationally offset from the inner portion 108, the crank plate, and the set of crank magnets 96. This rotational offset corresponds to torque applied to the torque sensor.

The torsion disc 86 has three arms 112a-112c evenly arrayed about the inner portion 108 in FIG. 7, and it will be appreciated that the torsion disc 86 may have more or fewer arms. Moreover, each arm 112a-112c may have a respective central portions 111a-111c that joins the arms 112a-112c to the inner portion 108. The central portions 111a-111c extend at least partially in a radial direction 83b away from the inner portion 108 to provide clearance between the arms 112a-112c and the inner portion 108. Also shown in FIG. 7 is a series of six brace rollers 118a-118f and respective brace pins 120a-120f, which are joined to the wheel. As the torque sensor receives torque, the brace rollers 118a-118f allow the wheel to stay centered relative to the torsion disc 86, and help ensure that deformation of the torsion disc 86 is limited to the arms 112a-112c and to the rotational direction. The torsion disc 86 can be made of any material described herein, or any other material where deformation of the torsion disc 86 is proportional to the torque experienced by the torsion disc 86.

Finally, FIG. 7 shows the alternating polarities of the magnets of the sets of magnets 96, 98. The set of crank magnets 96 has alternating north 100 and south 102 magnets, and the set of wheel magnets 98 has alternating north 104 and south 106 magnets. As depicted, the sets of magnets 96, 98 are offset in the rotational direction, and transitions between north 100 and south magnets 102 of the set of crank magnets 96 correspond to transitions between north 104 and south magnets 106 of the set of wheel magnets 98. As described herein, sensors detect the change in polarities at these transitions and the times for corresponding transitions are compared to determine a time offset, which is used to determine a torque applied to the torque sensor.

FIG. 8 is a perspective view of a wheel 84, which can serve as the output of the torque sensor. The wheel 84 has three distal recesses 122a-122c to receive respective distal pins (116a-116c in FIG. 7) of the arms. Further, the wheel 84 has six brace recesses 124a-124f to receive respective brace pins (120a-120f in FIG. 7). In some embodiments, the torque sensor has no brace recesses 124a-124f or brace pins. Moreover, it will be appreciated that in some applications, the outer component like the wheel 84 is the input and the inner component like the crankshaft (82 in FIG. 5A) is the output.

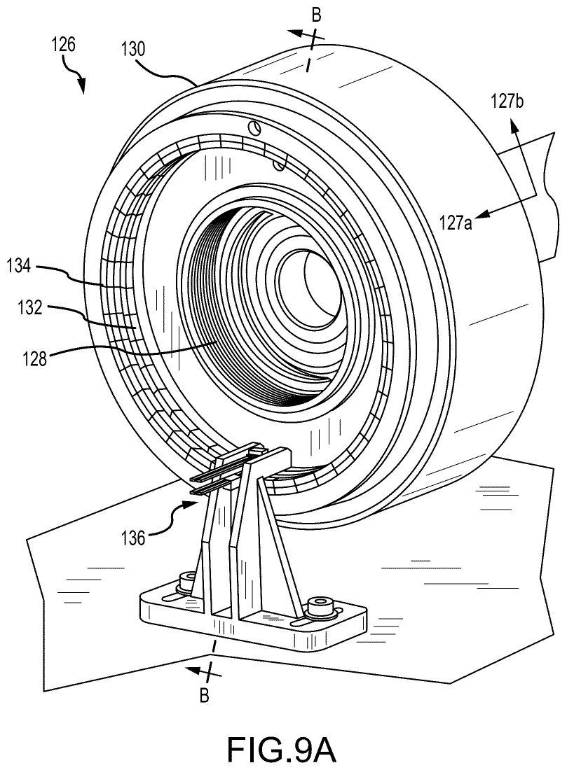

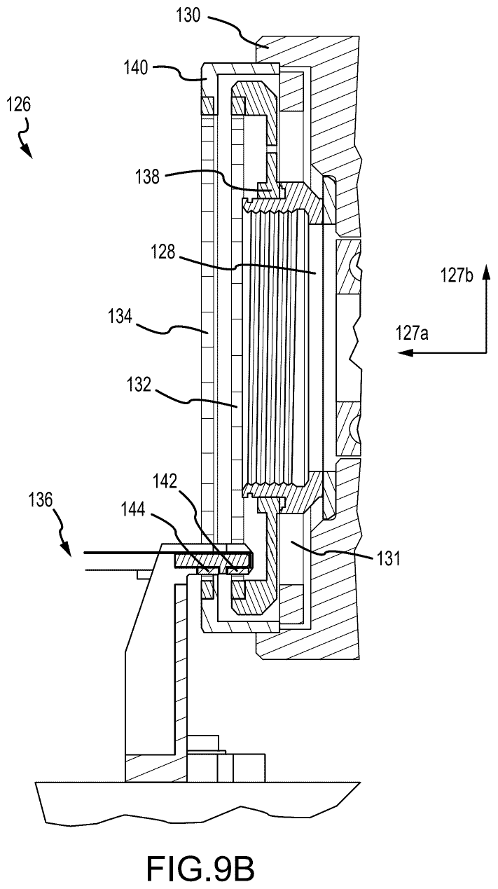

FIG. 9A is a perspective view of a torque sensor 126, and FIG. 9B is a cross-sectional view of the torque sensor 126 in FIG. 9A taken along line B-B. These figures show an embodiment of the torque sensor 126 with a sensor assembly 136 that is inwardly offset from sets of magnets 132, 134 in a radial direction 127b. Like the embodiment in FIGS. 5A-8 where the sensor assembly is outwardly offset in the radial direction, the embodiment depicted in FIGS. 9A and 9B reduces runout and the need for post-processing of readings from the sensor assembly 136. The axial direction 127a and the radial direction 127b can be in reference to the overall torque sensor 126, the components 128, 130 of the torque sensor 126, the torsion disc 131, etc.

The inner component 128 can be a crankshaft or joined to a component like a crankshaft, the outer component 130 can be a wheel or a component like a wheel. Then, a torsion disc 131 is operatively engaged to each of the inner component 128 and the outer component 130, the torsion disc 131 deforms in response to torque between the inner and outer components 128, 130. Like other embodiments described herein, the torsion disc 131 deforms in response to torque.

Next, a set of inner magnets 132 is associated with the inner component 128, and a set of outer magnets 134 is associated with the outer component 130. The set of inner magnets 132 is joined to an inner plate 138, which is joined to the inner component 128, and the set of outer magnets 134 is joined to an outer plate 140, which is joined to the outer component 130. These plates 138, 140 position the sets of magnets 132, 134 to be offset in the axial direction 127a. Moreover, these plates 138, 140 also provide space for the sensor assembly 136 to be offset in the radial direction 127b from the sets of magnets 132, 134. In some embodiments, the inner and outer components 128, 130 position the sets of magnets 132, 134 in this manner without the use of plates 138, 140. Each set of magnets 132, 134 has magnets arranged with alternating polarities (north, south, north, south, etc.), and the sensor assembly 136 detects the polarities of each set of magnets 132, 134. The time at which a transition in polarities between magnets of the set of inner magnets 132 occurs is compared to the time at which a transition in polarities between corresponding magnets of the set of outer magnets 134 occurs to determine a time offset. This time offset is used to determine a relative rotational position of the inner and outer components 128, 130, a deformation of the torsion disc 131, and an applied torque.

The sensor assembly 136 comprises an inner sensor 142 for detecting the polarities of magnets of the set of inner magnets 132 as these magnets rotate by the inner sensor 142. Similarly, the sensor assembly 136 comprises an outer sensor 144 for detecting the polarities of magnets of the set of outer magnets 134 as these magnets rotate by the outer sensor 144. The sensors 142, 144 can be, for instance, a Hall sensor or any other sensor described herein or sensor capable of detecting polarities of magnets.

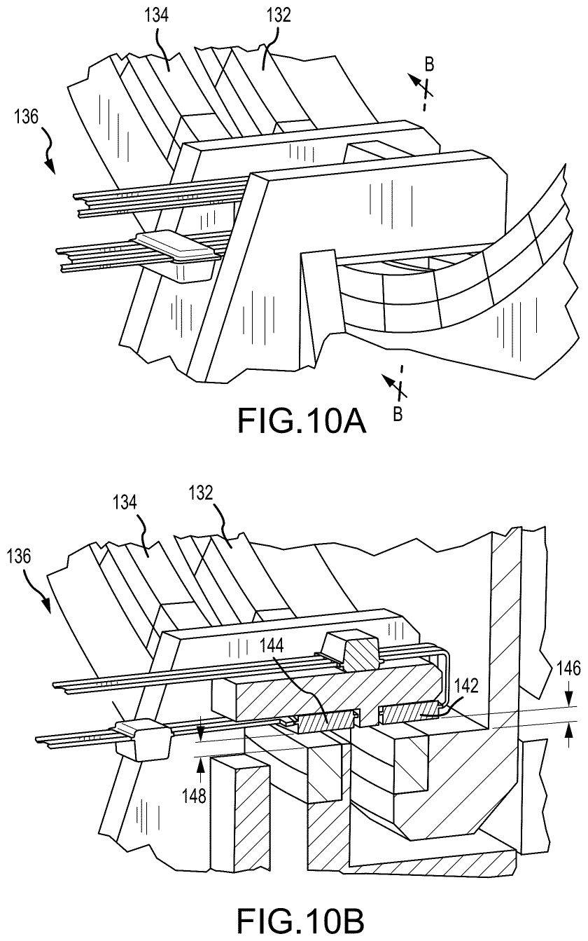

FIG. 10A is a perspective view of the sensor assembly 136, and FIG. 10B is a cross-sectional view of the sensor assembly 136 in FIG. 10A taken along line B-B. Here, the sensor assembly 136 has an inner sensor 142 that is offset from the set of inner magnets 132 in the radial direction (127b in FIGS. 9A and 9B) by an inner space 146. The sensor assembly 136 also has an outer sensor 144 that is offset from the set of outer magnets 134 in the radial direction (127b in FIGS. 9A and 9B) by an outer space 148. With the axial offset of the sets of magnets 132, 134 and the radial offset of the sensor assembly 136, the spaces 146, 148 experience less variation when there is variation in components of the overall torque sensor. This reduces runout and the need for post-processing of readings from the sensor assembly 136.

It will be appreciated that aspects, characteristics, features, components, etc. described with respect to one embodiment can be applied to any embodiment encompassed by the present disclosure. For instance, the embodiments encompassed by the present disclosure can be applied to a bicycle such as an e-bike, or any other application. Further still, the embodiments encompassed by the present disclosure can be made of any material described herein or otherwise in accordance with the present disclosure, embodiments encompassed by the present disclosure can have a maximum twist angle, any number of arms, etc.

While various embodiments of the present invention have been described in detail, it is apparent that modifications and alterations of those embodiments will occur to those skilled in the art. However, it is to be understood that such modifications and alterations are within the scope and spirit of the present invention, as set forth in the following claims. Further, the invention(s) described herein is capable of other embodiments and of being practiced or of being carried out in various ways. It is to be understood that the phraseology and terminology used herein is for the purpose of description and should not be regarded as limiting.

What is claimed is:

1. A torque sensor for detecting a torque between a first component and a second component, comprising:
a torsion disc having:
an inner portion configured to be engaged with the first component; and
an outer portion joined to the inner portion, and the outer portion is configured to be engaged with the second component;
a first set of alternating magnets associated with the inner portion of the torsion disc;
a second set of alternating magnets associated with the outer portion of the torsion disc; and
at least one sensor configured to detect polarities of the first and second sets of alternating magnets, which is used to determine the torque between the first component and the second component.

2. The torque sensor of claim 1, wherein the inner portion has an annular shape configured to completely circumscribe the first component.

3. The torque sensor of claim 1, wherein the outer portion of the torsion disc comprises:
a first arm partially extending about the inner portion;
a second arm partially extending about the inner portion; and
a third arm partially extending about the inner portion;
wherein a distal end of the first arm, a distal end of the second arm, and a distal end of the third arm are each configured to be engaged to the second component.

4. The torque sensor of claim 3, further comprising:
a first central portion joining a proximal end of the first arm to the inner portion;
a second central portion joining a proximal end of the second arm to the inner portion; and
a third central portion joining a proximal end of the third arm to the inner portion.

5. The torque sensor of claim 3, wherein the first arm, the second arm, and the third arm are symmetric about a rotational axis of the torsion disc.

6. The torque sensor of claim 3, wherein the first set of alternating magnets and the second set of alternating magnets are offset in an axial direction of the torsion disc, and the at least one sensor is offset from the first and second sets of alternating magnets in a radial direction of the torsion disc.

7. The torque sensor of claim 3, wherein the first and second sets of alternating magnets have an equal number of magnets and are each arranged in a circular pattern with equal diameters.

8. The torque sensor of claim 1, wherein a time offset between a time at which a transition in polarities of the first set of alternating magnets is detected by the at least one sensor and a time at which a transition in polarities of the second set of alternating magnets is detected by the at least one sensor, and the time offset is used to determine the torque between the first component and the second component.

9. A torque sensor for detecting a torque between a first component and a second component, comprising:
an inner portion configured to be engaged with the first component;
a first magnet associated with the inner portion;
an outer portion joined to the inner portion, and the outer portion is configured to be engaged with the second component, wherein the outer portion comprises:
a first arm partially extending about the inner portion;
a second arm partially extending about the inner portion; and
a third arm partially extending about the inner portion;
a second magnet associated with the outer portion; and
at least one sensor configured to detect polarities of the first and second magnets, which is used to determine the torque between the first and second components.

10. The torque sensor of claim 9, wherein the first magnet is part of a set of first magnets with alternating polarities, and the second magnet is part of a set of second magnets with alternating polarities.

11. The torque sensor of claim 10, wherein the at least one sensor comprises:
a first Hall sensor configured to detect a transition in polarities of the set of first magnets; and
a second Hall sensor configured to detect a transition in polarities of the set of second magnets, wherein a time offset in detection times of the transitions in polarities of the sets of first and second magnets is used to determine the torque between the first and second components.

12. The torque sensor of claim 10, wherein the sets of first and second magnets have an equal number of magnets and are each arranged in a circular pattern with equal diameters.

13. The torque sensor of claim 9, wherein the first magnet and the second magnet are offset in an axial direction of the torque sensor, and the at least one sensor is offset from the first and second magnets in a radial direction of the torque sensor.

14. The torque sensor of claim 9, wherein a torsion disc comprises the inner portion and the outer portion, and wherein the torsion disc has a maximum yield strength of at least approximately 1200 MPa.

15. A transmission for an electric motor-assisted vehicle, comprising:
a crankshaft rotatable about a rotational axis, wherein the crankshaft is configured to power a drive wheel to propel the electric motor-assisted vehicle;
an electric motor configured to power the drive wheel to propel the electric motor-assisted vehicle; and
a torque sensor having:
an inner portion engaged with the crankshaft;
an outer portion engaged with the drive wheel; and
at least one sensor configured to detect a relative rotational offset between the inner and outer portions, wherein the relative rotational offset is proportional to a torque applied to the crankshaft, and the electric motor is configured to transmit power to the drive wheel based on the torque to propel the electric motor-assisted vehicle.

16. The transmission of claim 15, wherein the inner portion of the torque sensor has an annular shape that completely extends around the crankshaft, and wherein the outer portion of the torque sensor comprises:
a first arm partially extending about the inner portion of the torque sensor;
a second arm partially extending about the inner portion of the torque sensor; and
a third arm partially extending about the inner portion of the torque sensor;
wherein a distal end of the first arm, a distal end of the second arm, and a distal end of the third arm are each configured to be engaged to the drive wheel.

17. The transmission of claim 15, further comprising:
a set of alternating inner magnets associated with the inner portion of the torque sensor; and
a set of alternating outer magnets associated with the outer portion of the torque sensor;
wherein the at least one sensor detects polarities of the sets of alternating inner and outer magnets, which is used to detect the relative rotational offset between the inner and outer portions of the torque sensor.

18. The transmission of claim 17, wherein the at least one sensor comprises:
an inner Hall sensor configured to detect a transition in polarities of the set of alternating inner magnets; and
an outer Hall sensor configured to detect a transition in polarities of the set of alternating outer magnets, wherein a time offset in detection times of the transitions of polarities of the sets of inner and outer magnets is used to determine a difference in rotational positions between the inner and outer portions, which is the relative rotational offset that is proportional to the torque applied to the crankshaft.

19. The transmission of claim 17, wherein the set of alternating inner magnets and the set of alternating outer magnets are offset in an axial direction of the torque sensor, and the at least one sensor is offset from the sets of alternating inner and outer magnets in a radial direction of the torque sensor.

20. The transmission of claim 15, further comprising:
a controller in communication with the electric motor; and
a battery in communication with the controller, wherein the controller is configured to receive an input signal from the at least one sensor, and wherein the controller is configured to cause the battery to supply electric power to the electric motor.
